(19) United States
(12) Patent Application Publication
(10) Pub. No.: US 2020/0003170 A1
(43) Pub. Date: Jan. 2, 2020

(54) Fuel Injector With Precluded Fuel Flow at Sac Volume

(71) Applicant: GM Global Technology Operations LLC, Detroit, MI (US)

(72) Inventors: Ronald O. Grover, JR., Northville, MI (US); Scott E. Parrish, Farmington Hills, MI (US); David J. Brooks, Pontiac, MI (US)

(21) Appl. No.: 16/025,213

(22) Filed: Jul. 2, 2018

(51) Int. Cl. F02M 61/18; F02M 61/10

(52) U.S. Cl. CPC F02M 61/1893; F02M 51/061; F02M 61/1853; F02M 61/10

(57) ABSTRACT

A fuel injector for an internal combustion engine. The fuel injector has a needle and a nozzle that inter-relate with each other in assembly. Relative movement between the needle and nozzle bring the fuel injector between a closed state of operation and an open state of operation amid use of the fuel injector. The nozzle has one or more passages therein through which fuel is discharged. Fuel flow is precluded at a sac volume of the fuel injector.

### INTRODUCTION

The present disclosure relates to fuel injectors equipped in automotive internal combustion engines.

Fuel delivery can impact the performance of internal combustion engines in automobiles. A direct fuel injector, for instance, is typically installed at a combustion chamber and is used to spray fuel directly into the combustion chamber. The fuel is atomized as it is forced through passages within a nozzle of the fuel injector. Configuring the nozzle, as well as configuring an accompanying fuel injector needle, to carry out precise fuel metering has been challenging, and has been especially challenging to satisfy the precision demanded by certain more advanced engine strategies such as advanced lean burn engine strategies.

### SUMMARY

In an embodiment, a fuel injector includes a needle and a nozzle. The nozzle receives the needle in assembly. The nozzle has one or more passages for discharged fuel flow amid use of the fuel injector. During use of the fuel injector, when the fuel injector is in an open state of operation and when the fuel injector is in a closed state of operation, fuel flow at a sac volume is precluded.

In an embodiment, the needle has a recess. The recess is defined in the needle in an inboard direction of the needle. The nozzle has a projection. The projection extends from the nozzle in an inboard direction of the nozzle. The recess receives the projection when the fuel injector is in the closed state of operation.

In an embodiment, the recess receives the projection when the fuel injector is in the open state of operation.

In an embodiment, the recess resides at an axially-central region of the needle. The preclusion of fuel flow is effected by way of the recess-projection receipt at the axially-central region.

In an embodiment, the needle has one or more protuberances. The protuberance(s) extends from the needle in an outboard direction of the needle. A section or more of the protuberance(s) spans through an inlet orifice of the passage(s) when the fuel injector is in the open state of operation.

In an embodiment, the section or more of the protuberance(s) further spans into the passage(s). The section or more of the protuberance(s) remains into the passage(s) when the fuel injector is in the open state of operation.

In an embodiment, the protuberance(s) has a working surface. The working surface directs delivery of fuel flow into the passage(s). The working surface is spaced from an inlet orifice edge when the fuel injector is in the open state of operation.

In an embodiment, the preclusion of fuel flow is effected by way of the protuberance(s) directing delivery of fuel flow into the passage(s). And the preclusion of fuel flow is effected by way of the protuberance(s) obstructing fuel flow to the sac volume.

In an embodiment, the needle has an outboard surface. The nozzle has an inboard surface. A first shape of the needle's outboard surface complements a second shape of the nozzle's inboard surface. The outboard and inboard surfaces make surface-to-surface abutment therealong and make surface-to-surface abutment at the passage(s) when the fuel injector is in the closed state of operation.

In an embodiment, the passage(s) includes a single inlet orifice. The single inlet orifice leads to a manifold. The manifold leads to multiple of passages that span from the manifold.

In an embodiment, the preclusion of fuel flow is effected by way of an absence of a sac volume. The sac volume would be defined between the surface-to-surface abutment of the outboard surface of the needle and the inboard surface of the nozzle.

In an embodiment, the needle, the nozzle, or both of the needle and nozzle, have one or more additive-manufactured portions. During use of the fuel injector, when the fuel injector is in the open state of operation, the additive-manufactured portion(s) aids in the delivery of fuel flow to the passage(s). Further, when the fuel injector is in the open state of operation, the additive-manufactured portion(s) precludes fuel flow at the sac volume.

In an embodiment, the additive-manufactured portion(s) includes a recess of the needle. The recess is defined inboard of the needle. The recess receives a projection of the nozzle when the fuel injector is in the open state of operation, and the recess receives the projection when the fuel injector is in the closed state of operation.

In an embodiment, the additive-manufactured portion(s) includes one or more protuberances of the needle. The protuberance(s) extends unitarily from the needle, and extends outboard of the needle. A section or more of the protuberance(s) spans through an inlet orifice of the passage(s) when the fuel injector is in the open state of operation. The section or more of the protuberance(s) spans into the passage(s) when the fuel injector is in the open state of operation.

In an embodiment, the additive-manufactured portion(s) includes an outboard surface of the needle. A first shape of the outboard surface complements a second shape of an inboard surface of the nozzle. The needle's outboard surface and the nozzle's inboard surface make surface-to-surface abutment therealong, and make surface-to-surface abutment at the passage(s) when the fuel injector is in the closed state of operation.

In an embodiment, a fuel injector includes a needle and a nozzle. The needle has an additive-manufactured portion. The nozzle receives the needle. The nozzle has one or more passages for discharged fuel flow amid use of the fuel injector. During use of the fuel injector, when the fuel injector is in an open state of operation, the additive-manufactured portion of the needle aids in the delivery of fuel flow to the passage(s). And when the fuel injector is in a closed state of operation, the additive-manufactured portion of the needle precludes fuel flow at a sac volume.

In an embodiment, the additive-manufactured portion is a recess. The recess is defined inboard of the needle. The recess resides at an axially-central region of the needle. The recess receives a projection of the nozzle when the fuel injector is in the open state of operation, and further receives the projection of the nozzle when the fuel injector is in the closed state of operation.

In an embodiment, the additive-manufactured portion is one or more protuberances. The protuberance(s) extends unitarily from the needle. The protuberance(s) further extends outboard of the needle. A section or more of the protuberance(s) spans through an inlet orifice of the passage(s) when the fuel injector is in the open state of operation. And the section or more of the protuberance(s) spans into the passage(s) when the fuel injector is in the open state of operation.

In an embodiment, the protuberance(s) has a working surface. The working surface directs delivery of fuel flow into the passage(s). The working surface is spaced from an inlet orifice edge when the fuel injector is in the open state of operation.

In an embodiment, the additive-manufactured portion is an outboard surface of the needle. A first shape of the outboard surface complements a second shape of an inboard surface of the nozzle. The needle's outboard surface and nozzle's inboard surface make surface-to-surface abutment at the passage(s) when the fuel injector is in the closed state of operation.

### BRIEF DESCRIPTION OF THE DRAWINGS

One or more aspects of the disclosure will hereinafter be described in conjunction with the appended drawings, wherein like designations denote like elements, and wherein:

FIG. 1 is a depiction of an example combustion chamber of an internal combustion engine with a direct fuel injector;

FIG. 2 is a schematic of the direct fuel injector that can be used with the internal combustion engine of FIG. 1;

FIG. 3 is an enlarged view of the direct fuel injector of FIG. 2;

FIG. 4 depicts a sectioned view of a needle and a nozzle of a previously-known direct fuel injector, the fuel injector being in a closed state of operation;

FIG. 5 depicts the fuel injector of FIG. 4 in an open state of operation;

FIG. 6 depicts a sectioned view of one embodiment of a needle and a nozzle with a precisely-manufactured portion, the accompanying fuel injector being in a closed state of operation;

FIG. 7 depicts the needle and nozzle of FIG. 6 with the fuel injector in an open state of operation;

FIG. 8 depicts a sectioned view of another embodiment of a needle and a nozzle with a precisely-manufactured portion, the accompanying fuel injector being in a closed state of operation;

FIG. 9 depicts an enlarged view of the precisely-manufactured portion of FIG. 8;

FIG. 10 depicts the needle and nozzle of FIG. 8 with the fuel injector in an open state of operation;

FIG. 11 depicts a sectioned view of yet another embodiment of a needle and a nozzle with a precisely-manufactured portion, the accompanying fuel injector being in a closed state of operation; and

FIG. 12 depicts the needle and nozzle of FIG. 11 with the fuel injector in an open state of operation.

### DETAILED DESCRIPTION

With reference to the drawings, various embodiments of a needle and a nozzle of a fuel injector are set forth that provide enhanced precision in fuel metering. A more-precisely-manufactured portion is introduced into the design and construction of the needles and nozzles to bring about the enhancement. Heightened rigor in fuel metering is often demanded by more advanced engine strategies, such as that exacted by advanced lean burn engine strategies. The needle and nozzle embodiments with the more-precisely-manufactured portion—among other possible advancements—facilitate control of fine fuel quantity delivery, minimize or altogether eliminate unwanted post fuel injections that occur after a closed state of operation, and curb an undesirable condition known as injector tip wetting in which deposits accumulate on a nozzle tip due to lingering fuel. In this way, the accompanying fuel injector operates more effectively and efficiently than before. While described in the context of an automotive application in this description, the needle and nozzle embodiments could be employed in non-automotive applications as well.

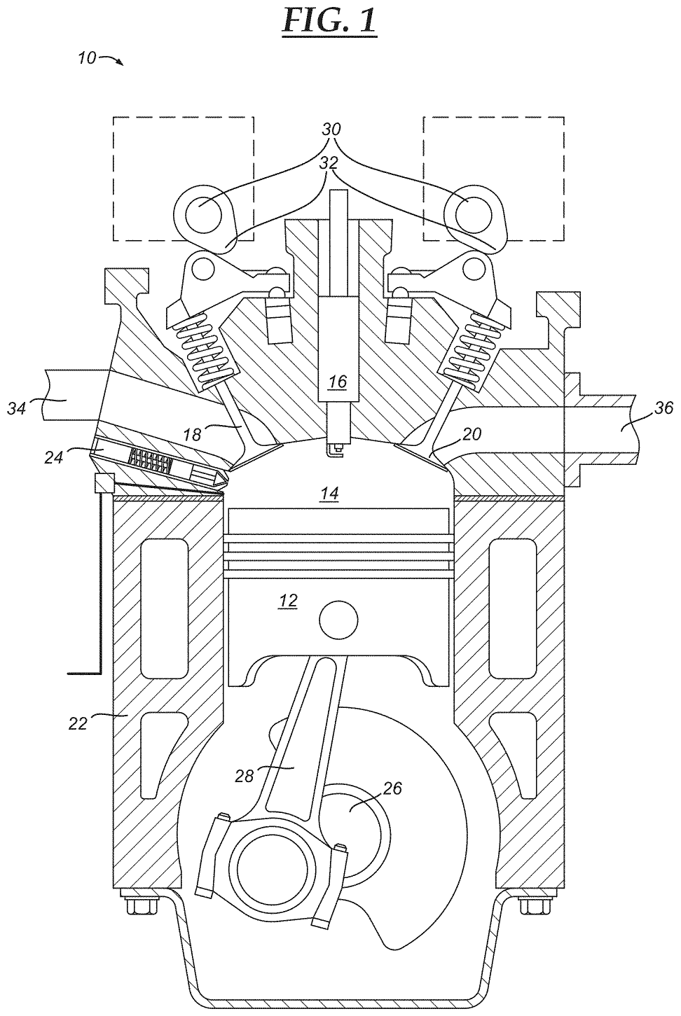

Referring now to FIG. 1, a section of an example internal combustion engine (ICE) 10 for an automobile is shown for explanatory purposes. In general, the ICE 10 includes a piston 12, a combustion chamber 14, a spark plug 16, an intake valve 18, an exhaust valve 20, a cylinder block 22, and a direct fuel injector 24. The piston 12 drives a crankshaft 26 by way of a connecting rod 28, and the intake and exhaust valves 18, 20 are actuated by camshafts 30 and their cams 32. The fuel injector 24 is used to inject fuel directly into the combustion chamber 14. At the appropriate time, a spark is initiated by the spark plug 16 to ignite an air-fuel mixture in the combustion chamber 14. An intake manifold 34 lets air into the combustion chamber 14, and an exhaust manifold 36 lets exhaust escape from the combustion chamber 14.

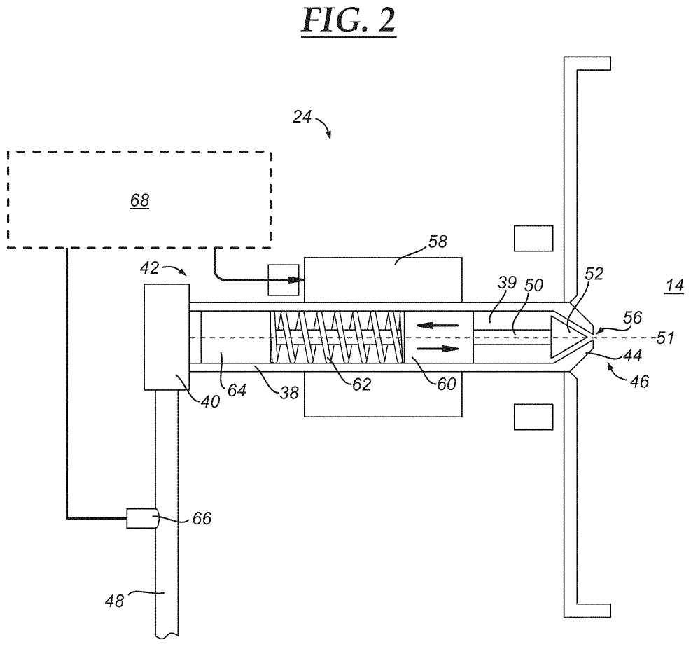

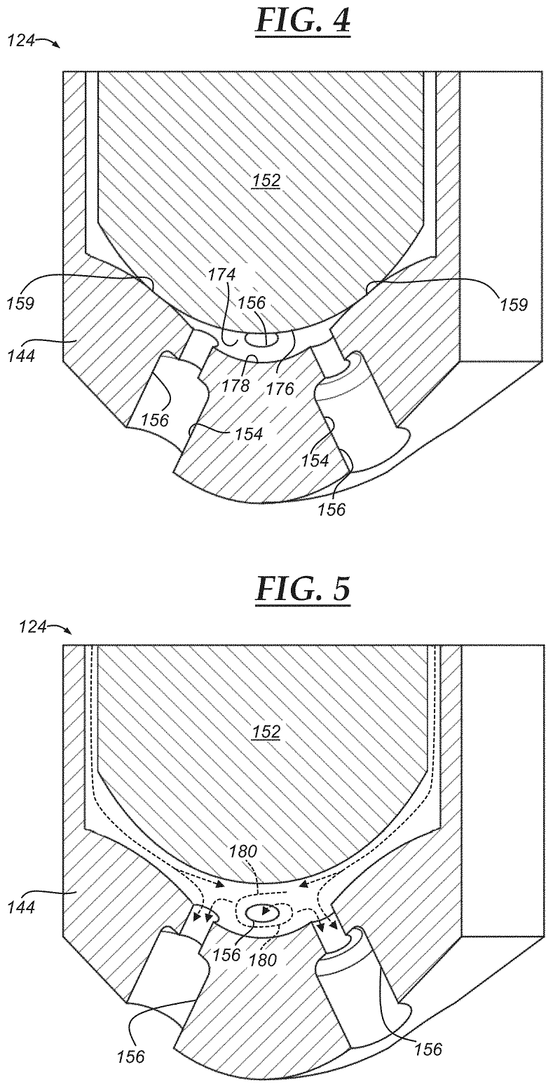

With reference to FIG. 2, an example of the fuel injector 24 is presented for explanatory purposes; skilled artisans will appreciate that other examples of fuel injectors could have different and/or other designs, constructions, and components than those set forth here. In the example, and in general, the fuel injector 24 includes a body 38 with a cavity 39 in which fuel can be communicated from a fuel inlet 40, to a nozzle 44, and ultimately out of passages 56. The fuel inlet 40 is located at a first end 42 of the body 38, and the nozzle 44 is located at a second end 46 of the body 38. The fuel inlet 40 is fed high-pressure fuel from a fuel line 48. A valve assembly is contained in the body 38, and includes a spring-activated plunger 50 and a needle 52, both of which are situated about a central longitudinal axis 51. The nozzle 44 has inner walls 154 (FIG. 4), each of which defines a passage 56 through which fuel is discharged when the fuel injector 24 is in an open and activated state of operation of the fuel injector 24. Further, the fuel injector 24 includes an electromagnetic coil 58 that is configured to magnetically engage a guide portion 60. When the electromagnetic coil 58 is deactivated, a valve spring 62 urges the needle 52 toward and against the nozzle 44 to prevent fuel flow through the passages 56—this condition constitutes a closed and deactivated state of operation of the fuel injector 24. When in the closed state, the needle 52 makes abutment with the nozzle 44 to form a sealing seat 159 therebetween (FIG. 4). The sealing seat 159 is circumferentially continuous around the needle 52 and nozzle 44 abutment interface, and obstructs fuel flow thereat. When the electromagnetic coil 58 is activated, electromagnetic force acts on the guide portion 60 and overcomes a spring force exerted by the valve spring 62 and urges the fuel injector 24 to its open state, retracting the needle 52 away from the nozzle 44 and permitting fuel flow through the passages 56.

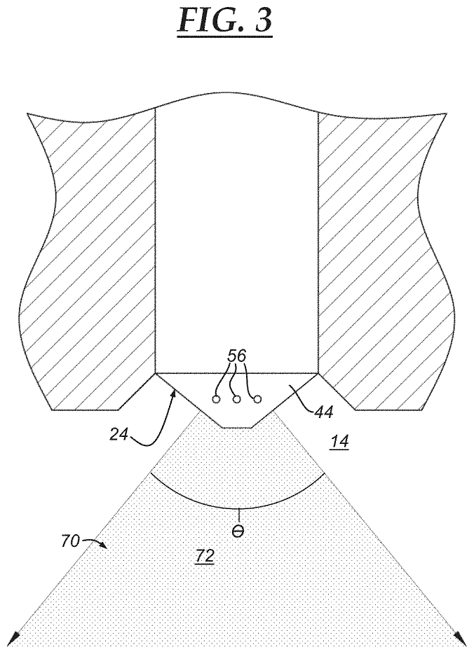

Furthermore, and still referring to FIG. 2, the fuel injector 24 may include a stopper 64 that halts movement of the needle 52 when the needle 52 retracts. A pressure sensor 66 may be included to monitor fuel pressure in the fuel line 48, and a control module 68 can receive signal outputs from the pressure sensor 66. The control module 68 can also be used to regulate activation and deactivation of the electromagnetic coil 58. Referring now to FIG. 3, the fuel injector 24 is depicted in general relation to the combustion chamber 14. A spray pattern 70 is produced when the fuel injector 24 sprays fuel 72 through the passages 56 of the nozzle 44. The spray pattern 70 makes a plume angle θ upon its discharge.

It has been found that the presence of fuel flow at a fuel injector sac volume can impact engine emissions involving unburned hydrocarbons and particulates, and can provoke fouling of the fuel injector due to formation of deposits (e.g., carbon deposits) on and at the fuel injector's nozzle, among other potential negative consequences. FIGS. 4 and 5 present a previously-known needle 152 and nozzle 144 of a fuel injector 124. A sac volume 174 is a defined space at a confrontation between an outboard surface 176 of the needle 152 and an inboard surface 178 of the nozzle 144 (the terms inboard and outboard are used here relative to a central longitudinal axis of the needle 152 and nozzle 144). The sac volume 174 can occupy the space radially inward of the sealing seat 159 and adjacent passages 156 (the term radially is used here relative to the generally cylindrical shapes of the needle 152 and nozzle 144). As illustrated in FIG. 5, in the open state, the sac volume 174 has been shown to contribute to complex internal fuel flow patterns 180 which, in some instances, can impact engine emissions, can incite fuel injector fouling, and can cause other unwanted conditions.

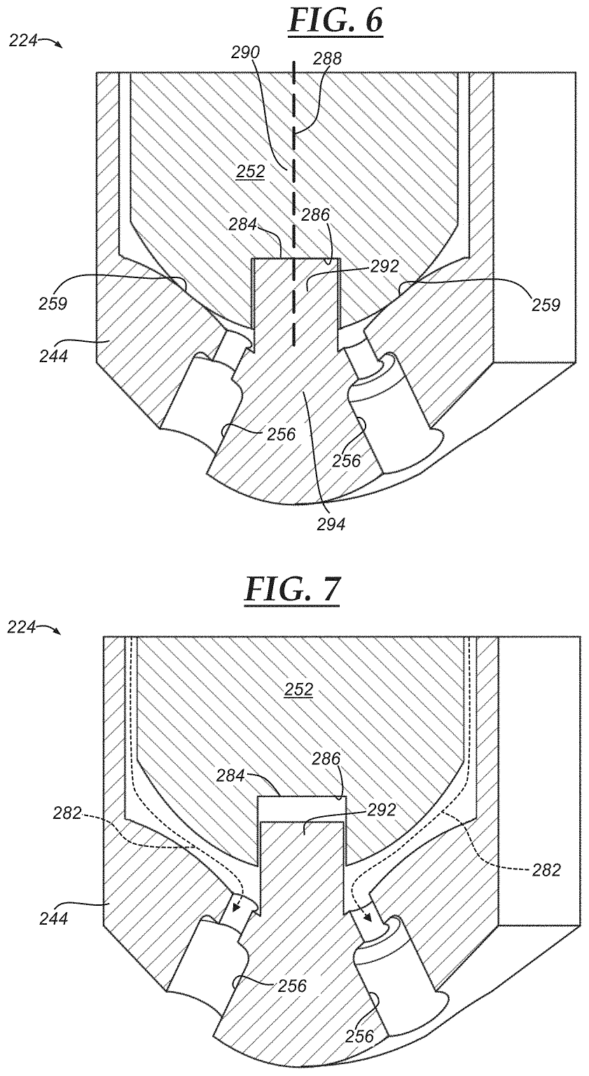

The needles and nozzles presented in FIGS. 6-12 have hence been designed and constructed with precisely-manufactured portions that are intended to resolve the above drawbacks. In the different embodiments described below, the precisely-manufactured portions aid in the delivery of fuel flow to the nozzle passages, preclude fuel flow at the sac volumes, effect an absence of a sac volume, or furnish a combination of these features. The precisely-manufactured portions can be made by various precise manufacturing technologies and techniques. One example involves additive manufacturing technologies and techniques; another example involves laser machining technologies and techniques; yet other examples include electro discharge machining (EDM) technologies and techniques, and LIGA (lithography, electroplating, and molding) technologies and techniques; still, other precise manufacturing technologies and techniques are possible. In the additive manufacturing example, in an embodiment, additive-manufactured portions are composed layer-upon-layer via a three-dimensional (3D) printing process, or can be composed via a direct digital manufacturing process. Still, other types of additive manufacturing processes are possible in other embodiments. The additive manufacturing technologies and techniques can be carried out to manufacture only the particular additive-manufactured portion, or can be carried out to manufacture the larger component from which the additive-manufactured portion extends, as set forth more below. The materials used in the additive manufacturing process can include certain metals and other suitable materials for fuel injector nozzles and/or needles.

FIGS. 6 and 7 present a first embodiment of a needle 252 and a nozzle 244 for a fuel injector 224. The fuel injector 224 is in its closed state of operation in FIG. 6 with the formation of a sealing set 259, and is in its open state of operation in FIG. 7 with fuel flow 282 exiting passages 256. In this embodiment, a precisely-manufactured portion 284 and, in this particular example an additive-manufactured portion 284, is in the form of a recess 286 defined in the needle 252. The needle 252 is manufactured via an additive manufacturing process such as a 3D printing process, with the recess 286 outfitted in the needle 252 amid the additive manufacturing process. The needle 252 can be composed of a hardened steel material in an example, or can be composed of another type of material; in the case of additive manufacturing, an example material can include nickel (Ni) alloy materials. The recess 286 can have a cylindrical shape, or can have another shape and another dimension. It has been found that certain more-precise manufacturing processes, and in this particular example, certain additive manufacturing processes are readily suited for producing the recess 286, while more traditional manufacturing techniques cannot always readily do so due to the preciseness demanded. As depicted in FIGS. 6 and 7, the recess 286 is defined in an inboard direction (i.e., upward in the FIGS.) of the needle 252 and is inset therein. The recess 286 is centered about a longitudinal axis 288 of the needle 252 and nozzle 244, and thus resides at an axially-central region 290 of the needle 252.

Furthermore, in this embodiment, the nozzle 244 has a projection 292 that is generally complementary to the recess 286 in terms of shape and location, and is received by the recess 286. Like the recess 286, the projection 292 can have a cylindrical shape or can have another shape. The projection 292 can be a unitary extension of the nozzle 244, and extends in an inboard direction (again, upwards in the FIGS.) of the nozzle 244. The projection 292 is centered about the longitudinal axis 288 and resides at an axially-central region 294 of the nozzle 244. At this location, the projection 292 is disposed central to and in-between the passages 256—however many passages there are—and occupies a space that would otherwise partly define a sac volume of the fuel injector 224. In this sense, the fuel injector 224 lacks a sac volume. In the closed state of operation of FIG. 6, the recess 286 receives full insertion of the projection 292. Interior surfaces of the recess 286 confront and can make abutment with exterior surfaces of the projection 292. In the open state of operation of FIG. 7, the recess 286 receives partial insertion of the projection 292, as illustrated. Fuel flow 282 is more readily delivered to the passages 256 via the maintained recess-projection reception and insertion, and the complex fuel flow patterns observed in past needles and nozzles is precluded due to an absence of a sac volume. Still, in other embodiments, the projection 292 itself could be manufactured via a more-precise manufacturing process such as additive manufacturing process and would therefore constitute an additive-manufactured portion. Yet furthermore, in other embodiments, the needle 252 could have the projection 292 and the nozzle 244 could have the matching recess 286.

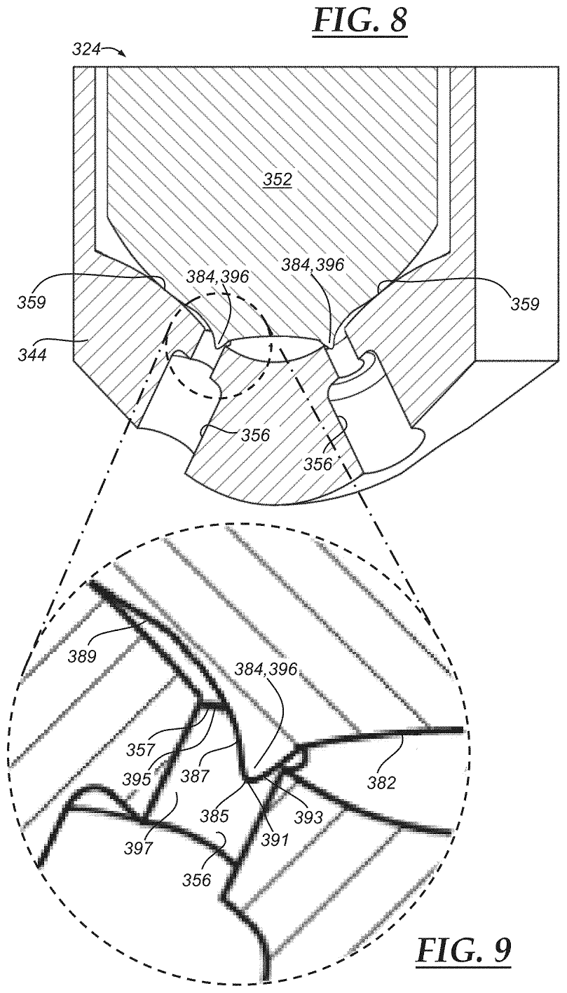

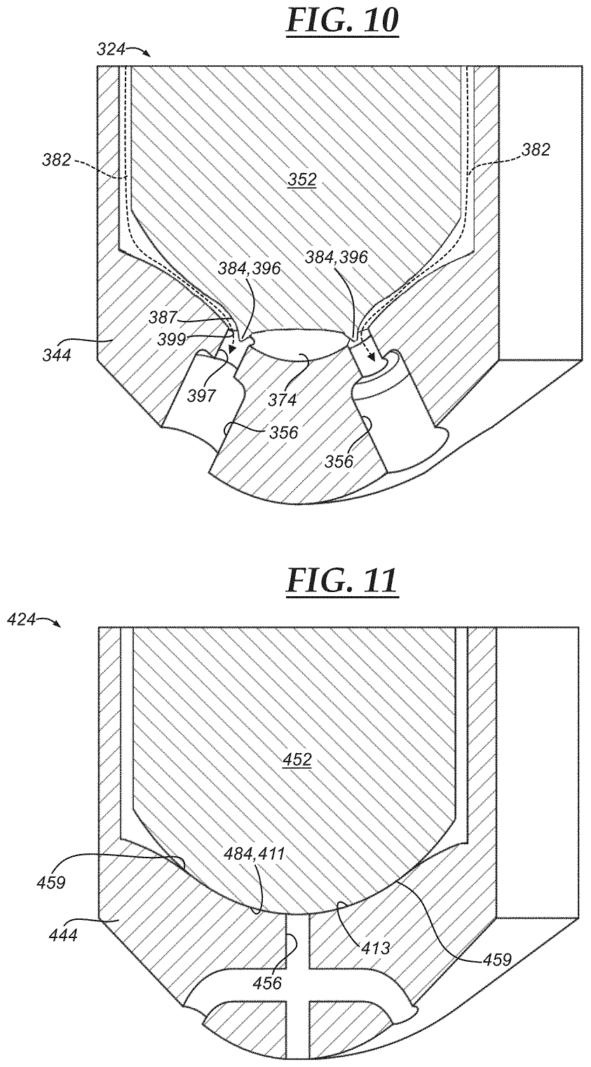

FIGS. 8, 9, and 10 present a second embodiment of a needle 352 and a nozzle 344 for a fuel injector 324. The fuel injector 324 is in its closed state of operation in FIGS. 8 and 9 with the formation of a sealing seat 359, and is in its open state of operation in FIG. 10 with fuel flow 382 exiting passages 356. In this embodiment, a precisely-manufactured portion 384 and, in this particular example an additive-manufactured portion 384, is in the form of multiple protuberances 396 extending from the needle 352. As before, the needle 352, along with the protuberances 396, is manufactured via a more-precise manufacturing process such as an additive manufacturing process. It has been found that certain more-precise manufacturing processes, and in this particular example, certain additive manufacturing processes are readily suited for producing the protuberances 396, while more traditional manufacturing techniques cannot always readily do so due to the preciseness demanded. The quantity of individual protuberances 396 equals the quantity of individual passages 356—in other words, there is a single protuberance 396 dedicated to each passage 356 in the nozzle 344. As depicted in FIGS. 8-10, the protuberances 396 extend in an outboard direction (i.e., downward in the FIGS.) of the needle 352, and extend toward a tip end of the nozzle 344. The protuberances 396 are each a unitary extension of a body of the needle 352, and hence the protuberances 396 and body constitute a monolithic structure of the needle 352. The protuberances 396 are situated at an end of the needle 352 at locations that coordinate their insertion with respective passages 356.

As perhaps presented best by the enlarged view of FIG. 9, in this embodiment each protuberance 396 has a lobe-like shape with a somewhat pointed and slightly rounded terminal end 385; still, the protuberances 396 can have other shapes in other embodiments. Each protuberance 396 in the embodiment of FIG. 9 has a front and working surface 387 that comes into contact with fuel flow 382 when the fuel injector 324 is in the open state of operation. The working surface 387 is sloped from a proximal end 389 to a distal end 391. The distal end 391 constitutes the axially-outboard-most portion of the protuberance 396. The slope of the working surface 387 directs and leads fuel flow 382 into the accompanying passage 356. Opposite the working surface 387, each protuberance 396 has a back surface 393 that lacks directs confrontation with fuel flow 382 when the fuel injector 324 is in the open state of operation.

In the closed state of operation, a section or more of each protuberance 396 spans through an entrance or inlet orifice 357 of the accompanying passage 356, and spans into the passage 356, as illustrated in FIG. 9. Here, a region of the working surface 387 and of the terminal end 385 are located within the passage 356. In a similar manner, in the open state of operation of FIG. 11, a section or more of each protuberance 396 spans through the inlet orifice 357 and spans into the passage 356. Here too, a region of the working surface 387 and of the terminal end 385 are located within the passage 356. Further, in the open state of operation, the working surface 387 is spaced away from an inlet orifice edge 395 (FIG. 9) in both the radial and axial directions with respect to the cylindrical shape of the passage 356. The resulting space occupied between an inner surface 397 and the working surface 387 serves as an inlet passage 399 that fluidly communicates directly and immediately with the passage 356, and hence leads fuel flow 382 into the passage 356. Moreover, because of their shapes and locations relative to the passages 356, the protuberances 396 obstruct and block fuel flow 382 to a sac volume 374, both when the fuel injector 324 is in the closed state of operation and when the fuel injector 324 is in the open state of operation.

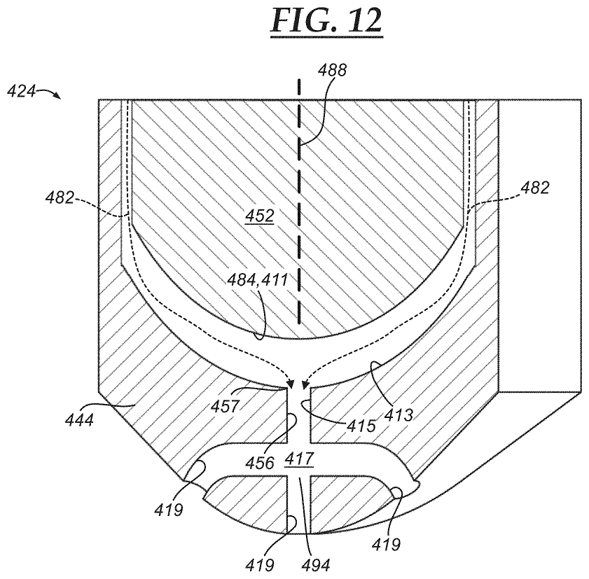

FIGS. 11 and 12 present a third embodiment of a needle 452 and a nozzle 444 for a fuel injector 424. The fuel injector 424 is in its closed state of operation in FIG. 11 with the formation of a sealing seat 459, and is in its open state of operation in FIG. 12 with fuel flow 482 passing through a passage 456. In this embodiment, a precisely-manufactured portion 484 and, in this particular example an additive-manufactured portion 484, is in the form of an outboard surface 411 of the needle 452 with a shape that complements and matches that of the nozzle 444. As before, the needle 452, along with the outboard surface 411, is manufactured via a more-precise manufacturing process such as an additive manufacturing process. It has been found that certain more-precise manufacturing processes, and in this particular example, certain additive manufacturing processes are readily suited for producing the outboard surface 411 and its complementary shape, while more traditional manufacturing techniques cannot always readily do so due to the preciseness demanded. As mentioned, the outboard surface 411 is made to have a first shape that precisely corresponds to a second shape of an inboard surface 413 of the nozzle 444 such that the outboard and inboard surfaces 411, 413 make surface-to-surface abutment with each other when the fuel injector 424 is in the closed state of operation, as shown in FIG. 11. Such surface-to-surface preciseness was previously not possible with more traditional manufacturing techniques in a mass production setting. In cross-section, the first shape of the outboard surface 411 is spherical and convex, and the second shape of the inboard surface 413 is spherical and concave.

Furthermore, in the third embodiment, the passage 456 can be designed and constructed with a single inlet orifice 457 and single inlet passage 415, as opposed to having the multiple separate and distinct passages of previous embodiments. The single inlet orifice 457 and passage 415 are centered about a longitudinal axis 488 of the needle 452 and nozzle 444, and thus reside at an axially-central region 494 of the nozzle 444. A manifold 417 spans from the single inlet orifice 457 and passage 415, and fluidly communicates therewith. Multiple separate and distinct passages 419 branch out from the manifold 417 and ultimately exit the nozzle 444. Because of their precisely corresponding shapes and attendant surface-to-surface abutment of the outboard and inboard surfaces 411, 413, the complex fuel flow patterns observed in past needles and nozzles is precluded due to an altogether absence of a sac volume.

In alternatives to the third embodiment, the inboard surface 413 of the nozzle 444 could be manufactured via an additive manufacturing process; and/or the passage 456 need not be designed and constructed with a single inlet orifice and passage, and rather the fuel injector 424 could have the passages as presented in previous embodiments.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A fuel injector, comprising:
a needle; and
a nozzle receiving the needle and having at least one passage for discharged fuel flow;
wherein, during use of the fuel injector, when the fuel injector is in an open state of operation and when the fuel injector is in a closed state of operation, fuel flow at a sac volume is precluded.

2. The fuel injector of claim 1, wherein the needle has a recess defined inboard of the needle, the nozzle has a projection extending inboard of the nozzle, and the recess receives the projection when the fuel injector is in the closed state of operation.

3. The fuel injector of claim 2, wherein the recess receives the projection when the fuel injector is in the open state of operation.

4. The fuel injector of claim 3, wherein the recess resides at an axially-central region of the needle, and the preclusion of fuel flow is effected via the recess-projection receipt at the axially-central region.

5. The fuel injector of claim 1, wherein the needle has at least one protuberance extending outboard of the needle, and at least a section of the at least one protuberance spans through an inlet orifice of the at least one passage when the fuel injector is in the open state of operation.

6. The fuel injector of claim 5, wherein the at least section of the at least one protuberance spans into the at least one passage, and wherein the at least section of the at least one protuberance remains into the at least one passage when the fuel injector is in the open state of operation.

7. The fuel injector of claim 5, wherein the at least one protuberance has a working surface that directs delivery of fuel flow into the at least one passage and that is spaced from an inlet orifice edge when the fuel injector is in the open state of operation.

8. The fuel injector of claim 5, wherein the preclusion of fuel flow is effected via the at least one protuberance directing delivery of fuel flow into the at least one passage and obstructing fuel flow to the sac volume.

9. The fuel injector of claim 1, wherein the needle has an outboard surface, the nozzle has an inboard surface, a first shape of the outboard surface complementing a second shape of the inboard surface, wherein the outboard and inboard surfaces make surface-to-surface abutment therealong and at the at least one passage when the fuel injector is in the closed state of operation.

10. The fuel injector of claim 9, wherein the at least one passage includes a single inlet orifice, the single inlet orifice leading to a manifold with a plurality of passages spanning therefrom.

11. The fuel injector of claim 9, wherein the preclusion of fuel flow is effected via an absence of a sac volume between the surface-to-surface abutment of the outboard surface of the needle and the inboard surface of the nozzle.

12. The fuel injector of claim 1, wherein the needle, the nozzle, or both of the needle and nozzle, have at least one additive-manufactured portion, and wherein during use of the fuel injector, when the fuel injector is in the open state of operation, the at least one additive-manufactured portion aids in the delivery of fuel flow to the at least one passage and precludes fuel flow at the sac volume.

13. The fuel injector of claim 12, wherein the at least one additive-manufactured portion includes a recess of the needle that is defined inboard of the needle, the recess receiving a projection of the nozzle when the fuel injector is in the open state of operation and when the fuel injector is in the closed state of operation.

14. The fuel injector of claim 12, wherein the at least one additive-manufactured portion includes at least one protuberance of the needle that extends unitarily from the needle and extends outboard of the needle, at least a section of the at least one protuberance spans through an inlet orifice of the at least one passage when the fuel injector is in the open state of operation and spans into the at least one passage when the fuel injector is in the open state of operation.

15. The fuel injector of claim 12, wherein the at least one additive-manufactured portion includes an outboard surface of the needle, a first shape of the outboard surface complementing a second shape of an inboard surface of the nozzle, wherein the outboard and inboard surfaces make surface-to-surface abutment therealong and at the at least one passage when the fuel injector is in the closed state.

16. A fuel injector, comprising:
a needle having an additive-manufactured portion; and
a nozzle receiving the needle and having at least one passage for discharged fuel flow;
wherein, during use of the fuel injector, when the fuel injector is in an open state of operation the additive-manufactured portion aids in delivery of fuel flow to the at least one passage, and when the fuel injector is in a closed state of operation the additive-manufactured portion precludes fuel flow at a sac volume.

17. The fuel injector of claim 16, wherein the additive-manufactured portion is a recess defined inboard of the needle, the recess residing at an axially-central region of the needle and receiving a projection of the nozzle when the fuel injector is in the open state of operation and receiving the projection when the fuel injector is in the closed state of operation.

18. The fuel injector of claim 16, wherein the additive-manufactured portion is at least one protuberance extending unitarily from the needle and extending outboard of the needle, at least a section of the at least one protuberance spanning through an inlet orifice of the at least one passage and spanning into the at least one passage when the fuel injector is in the open state of operation.

19. The fuel injector of claim 18, wherein the at least one protuberance has a working surface that directs delivery of fuel flow into the at least one passage and that is spaced from an inlet orifice edge when the fuel injector is in the open state of operation.

20. The fuel injector of claim 16, wherein the additive-manufactured portion is an outboard surface, a first shape of the outboard surface complementing a second shape of an inboard surface of the nozzle, the outboard and inboard surfaces making surface-to-surface abutment at the at least one passage when the fuel injector is in the closed state of operation.
